(19) United States
(12) Patent Application Publication
(10) Pub. No.: US 2017/0016987 A1
(43) Pub. Date: Jan. 19, 2017

(54) PROCESSING SYNTHETIC APERTURE RADAR IMAGES FOR SHIP DETECTION

(71) Applicant: HER MAJESTY THE QUEEN IN RIGHT OF CANADA, AS REPRESENTED BY THE MINISTER OF NATIONAL DEFENCE, Ottawa (CA)

(72) Inventors: Christoph H. GIERULL, Ottawa (CA); Ishuwa C. SIKANETA, Stittsville (CA)

(21) Appl. No.: 14/801,976

(22) Filed: Jul. 17, 2015

(51) Int. Cl. G01S 13/90; G06T 7/40; G06T 7/00

(52) U.S. Cl. CPC G01S 13/9035; G06T 7/0081; G06T 7/40; G06T 2207/10044

(57) ABSTRACT

Systems and methods relating to SAR image processing and object detection within a SAR image. A sea clutter model in which the texture random variable is drawn from a finite and discrete set of values is used in the processing of SAR derived images. SAR images are divided into sub-images, each sub-image being processed in turn. A statistical test is applied to each sub-image to determine whether it contains pixels representing only non-clutter information. The statistical test is based on the sea-clutter model, parameters of which are derived and adapted from each sub-image. The model is designed such that it will not permit more than a pre-determined number of false alarms. Pixels in each sub-image with information other than clutter are clustered, according to proximity, into object detections. Detections from all sub-images are combined to provide global object detection and to group clusters that may have split across sub-image boundaries.

### TECHNICAL FIELD

The present invention relates to SAR image processing. More specifically, the present invention relates to systems and methods for processing images obtained by a synthetic aperture radar (SAR) to detect objects in the images.

### BACKGROUND OF THE INVENTION

Advances in radar and image processing technology have provided the world with the ability to image the world from space. Satellite based synthetic aperture radar (SAR) allows images of the Earth to be taken from outer space with resolutions of up to mere meters. This allows an unprecedented opportunity for surveillance of potential seaborne threats to coastlines and harbours. However, current technology requires prodigious amounts of processing before clear images of ships and seaborne artifacts can be derived from SAR images.

Currently, vessel detection based on single-polarised SAR images is achieved through a statistical detection step in which a ship detection is declared when a pixel magnitude exceeds a predetermined threshold. The threshold is computed based on a statistical model of the measured SAR magnitude sea background data, or in radar terms, the clutter. Currently, virtually all operational space-based SAR vessel detectors employ minor variants of two statistical clutter models: a) a Gaussian-distribution based model or b) the K-distribution based model, which is based on a composite model taking into account inhomogeneity in the background texture.

Once normalized to its average magnitude value, the distribution functions are parameterized through a-priori unknown parameters which are adaptively estimated to fit the measured data. For Gaussian clutter, one parameter is a scaled variance and for the K-distribution, one is a texture parameter. The estimated values for these parameters are subsequently inserted into the model to determine the desired detection threshold.

Although the Gaussian distribution is widely used for the clutter in low-resolution SAR images, it is an inaccurate model unless a larger number of independent pixels are averaged, which is impractical as it would severely reduce the target SNR and hence its detectability. For commonly used single-look images, the assumption of Gaussian clutter breaks down. This is especially true for high-resolution imagery where the radar essentially resolves some of the large-scale structures of the sea surface and thereby becomes heterogeneous (i.e. non-Gaussian distributed).

The more sophisticated K-distribution model incorporates this texture inhomogeneity by utilizing a second independent multiplicative texture random variable. Although more physically sensible than the Gaussian model, the K-distribution model is inherently based on the assumption that unavoidable thermal white noise caused by the electronic system components is negligible. However, this assumption is only justified for high power levels (i.e. when the clutter power level is significantly larger than the thermal noise), such as for airborne SAR systems which involve available large transmit power and relatively short stand-off ranges. For space-based SAR, however, this assumption is generally not valid, manifesting itself in a deviation of the anticipated K-distribution model from the measured data. This deviation will, in principle, result in an overestimation of the detection threshold, potentially leading to many missed targets such as those that are smaller and hence have weaker reflection. This is more pronounced in heterogeneous clutter caused by high sea states. Further, the mathematical description of the K-distribution function involves highly nonlinear functions (e.g. Bessel-functions), which makes the adaptive estimation of the texture parameter, the threshold, and figures of merit (such as the probability of detection) a numerically challenging and time consuming endeavour.

There is therefore a need for methods and systems which mitigate if not avoid the drawbacks of the prior art. Preferably, these systems and devices will avoid the use of the K-distribution model and the use of the Gaussian distribution model.

### SUMMARY OF INVENTION

The present invention provides systems and methods relating to image processing. A sea clutter model in which the texture random variable is drawn from a finite and discrete set of values is used in the processing of SAR derived images. The SAR images are divided into sub-images, with each sub-image being processed in turn. A statistical test is then applied to each sub-image to determine whether it contains pixels representing only clutter or whether it contains pixels which contain non-clutter information. The statistical test is based on the sea-clutter model, parameters of which are derived and adapted from each sub-image. The model is designed such that it will not permit more than a pre-determined number of false alarms. Pixels in each sub-image that are determined to contain information other than clutter are clustered, according to proximity, into object detections. The detections from all sub-images are combined to provide global object/vessel detection and to group clusters that may have split across sub-image boundaries.

In a first aspect, the present invention provides a method for processing a radar image to detect at least one object in said image, the method comprising:
a) receiving said radar image;
b) dividing said image into multiple sub-images;
c) processing each sub-image by:
   i) estimating parameters from said sub-image for use in calculating a texture random variable;
   ii) calculating a detection threshold for said sub-image based on said parameters estimated in step i)
   iii) for each pixel in said sub-image, determining if said pixel contains clutter or non-clutter content based on said detection threshold;
   iv) for each pixel in said sub-image, classifying said pixel as containing clutter or non-clutter content based on a determination in step iii);
   v) saving coordinates of each pixel containing non-clutter content into a global set of non-clutter pixels;
d) repeating step c) until all sub-images have been processed;
e) processing said global set of non-clutter pixels to result in subsets of pixels containing non-clutter content, each subset containing pixels having non-clutter content from a specific object, pixels in each subset being within a predetermined proximity to one another;
   wherein said radar image is an image of a section of sea; and
   wherein said radar image is produced by a synthetic aperture radar.

In a second aspect, the present invention provides a system for processing radar images, the system comprising:
an input module for receiving a radar image;
an image divider module for dividing said radar image into sub-images;
a non-clutter detection module for processing sub-images derived from said input radar image, said detection module determining if pixels in a sub-image contains clutter or non-clutter information;
a clustering module for determining a location of pixels containing non-clutter information in said sub-images and for creating subsets of pixels containing non-clutter information, pixels in a subset being within a predetermined distance from other pixels in said subset;
wherein
said non-clutter detection module processes each of said sub-images by calculating a detection threshold based on parameters from said sub-image and comparing information from each pixel in said sub-image with said detection threshold.

In a third aspect, the present invention provides non-transitory computer readable media having encoded thereon computer readable and computer executable instructions which, when executed, implements a method for processing a radar image to detect at least one object in said image, the method comprising:

a) receiving said radar image;
b) dividing said image into multiple sub-images;
c) processing each sub-image by:
i) estimating parameters from said sub-image for use in calculating a texture random variable;
ii) calculating a detection threshold for said sub-image based on said parameters estimated in step i)
iii) for each pixel in said sub-image, determining if said pixel contains clutter or non-clutter content based on said detection threshold;
iv) for each pixel in said sub-image, classifying said pixel as containing clutter or non-clutter content based on a determination in step iii)
v) saving coordinates of each pixel containing non-clutter content into a global set of non-clutter pixels;
   d) repeating step c) until all sub-images have been processed;
   e) processing said global set of non-clutter pixels to result in subsets of pixels containing non-clutter content, each subset containing pixels having non-clutter content from a specific object, pixels in each subset being within a predetermined proximity to one another;
   wherein said radar image is an image of a section of sea; and
   wherein said radar image is produced by a synthetic aperture radar.

### BRIEF DESCRIPTION OF THE DRAWINGS

The embodiments of the present invention will now be described by reference to the following figures, in which identical reference numerals in different figures indicate identical elements and in which:

FIG. 1 is a flowchart of a method according to one aspect of the invention;

FIG. 2 is a plot of the distribution function of sea clutter comparing two ways of modeling sea clutter; and

FIG. 3 is a block diagram of a system according to another aspect of the invention.

### DETAILED DESCRIPTION

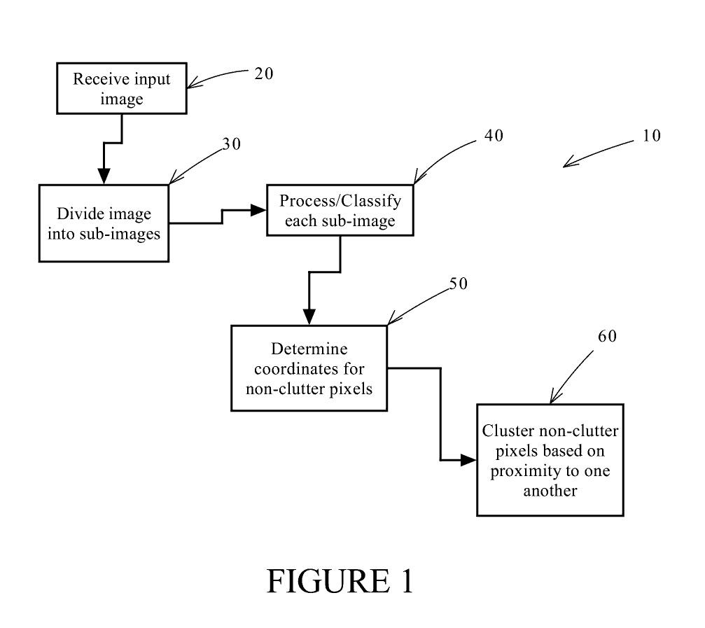

Referring to FIG. 1, a flowchart according to one aspect of the invention is illustrated. The flowchart 10 begins at step 20 where the input image is received. The image is that of a sea or ocean (i.e. mostly water) region and is gathered using one or more synthetic aperture radars.

Step 30 then divides the image into multiple sub-images. The division of the image may be region based or content based. A region based approach divides the image into regions and each region becomes a sub-image. A content based approach divides the image based on the content. Thus, as an example, a section of the image with mostly dark pixels would form one sub-image while a section with mostly light pixels would form another sub-image. Another alternative divides the input image into sub-images of a fixed size and resolution. This would split each input image into a predetermined number of sub-images for further processing.

In step 40, each sub-image is processed in turn. Processing each sub-image involves applying a novel model for sea clutter. This model, in contrast to previously used models, defines the sea clutter texture random variable as being a number drawn randomly from a finite and discrete set (where each element represents a scatter type) rather than a number drawn randomly from a continuous, infinite set. The elements of the finite discrete set (their values and the size of the set) as well as the way in which these numbers are randomly selected are estimated from the sub-image data.

As part of step 40, the parameters for each sub-image are determined/estimated based on the contents of each sub-image. These parameters may include the elements of the finite discrete set, how many elements in the discrete set, and how the numbers are randomly selected from within the set.

Returning to the model for sea clutter, the model defines the texture random variable, Σ, to be a discrete random variable with a probability distribution function

$${f}_{\sum } ( σ ) = {\sum }_{i = 1}^{I} {c}_{i} δ ( σ - {a}_{i} ) {\sum }_{i = 1}^{I} {c}_{i} = 1 ,$$

where I, cᵢ and aᵢ are to be determined from the data (i.e. from data within the sub-image). The aᵢ variable defines the set of values that the texture random variable can assume, the cᵢ variable defines their probability of being selected randomly, and I, a finite variable, defines the number of values in the set. The statistical distribution for the clutter then becomes

$${f}_{T} ( t , Θ ) = \frac{{n}^{n}}{Γ ( n )} {t}^{n - 1} {\sum }_{i = 1}^{I} {c}_{i} \frac{exp ( - \frac{nt}{{ρ}_{c} {a}_{i}^{2} + {ρ}_{n}} )}{{( {ρ}_{c} {a}_{i}^{2} + {ρ}_{n} )}^{n}}$$

$$with$$

$${ρ}_{c} + {ρ}_{n} = \frac{{σ}_{c}^{2}}{{σ}_{c}^{2} + {σ}_{n}^{2}} + \frac{{σ}_{n}^{2}}{{σ}_{c}^{2} + {σ}_{n}^{2}} = 1 ,$$

where n denotes the number of independent samples averaged, called number-of-looks, Θ denotes a vector containing all unknown parameters, and σ_{c}² and σ² are the clutter and thermal noise power levels, respectively.

The a priori unknown model parameters can be estimated using the Method-of-Moments (MoM), in which the theoretical values for the r-th central moment

$${ET}^{r} = \frac{1}{n} \frac{Γ ( n + r )}{Γ ( n )} {\sum }_{i = 1}^{I} {{c}_{i} ( {ρ}_{c} {a}_{i}^{2} + {ρ}_{n} )}^{r}$$

are fitted to the measured moments tᵣ in a Least-Square sense:

$${arg min}_{Θ} {\sum }_{i = 1}^{R} {( {ET}^{r} ( Θ ) - {t}_{r} )}^{2} {t}_{r} = \frac{1}{M} {\sum }_{m = 1}^{M} {t}_{m}^{r}$$

Note that r does not need to be an integer value and the number of moments R can be arbitrarily chosen but must be larger than the total number of unknown parameters.

Once the various parameters for each sub-image have been determined, a detection threshold using those parameters for this sub-image is then calculated. For this, the cumulative distribution function (cdf) of the discrete clutter model is utilized:

$${F}_{T} ( t , Θ ) = 1 - {\sum }_{i = 1}^{I} {c}_{i} \frac{Γ ( n , \frac{nt}{{ρ}_{c} {a}_{i}^{2} + {ρ}_{n}} )}{Γ ( n )} ,$$

in which Γ(•) represents the gamma function and Γ(•, •) the incomplete gamma function, respectively.

More specifically, for an operator pre-determined false alarm rate P_{fa}, and using the estimated model parameters determined above, the detection threshold η is computed by numerically inverting the equation:

$${P}_{fa} ( η , Θ ) = 1 - {F}_{T} ( η , Θ ) = {\sum }_{i = 1}^{I} {c}_{i} \frac{Γ ( n , \frac{ηη}{{ρ}_{c} {a}_{i}^{2} + {ρ}_{n}} )}{Γ ( n )} .$$

The detection threshold is then applied to each pixel within that sub-image. If the contents of that pixel meets or exceeds the detection threshold value, then that pixel is classified as a non-clutter pixel. If the pixel's contents do not meet the detection threshold value, then the pixel is considered to be a clutter pixel. It should be clear that each sub-image may have different parameters and, as such, each sub-image may have different detection thresholds from other sub-images.

Once the various sub-images have been processed, the sub-images containing only clutter information may be discarded or be set aside for no further processing. The sub-images containing non-clutter information, on the other hand, are processed further.

It should be noted that the estimated and combined clutter parameters determined in step 40 for each sub-image may be used to generate a clutter characterization map. Such a map would allow for the classification of different sea surface features such as currents, water-land boundaries, etc.

Returning to FIG. 1, in step 50, the coordinates for the non-clutter pixels are determined and these coordinates are placed into a global set of coordinates. These coordinates identify the locations of all non-clutter pixels in all sub-images, taking into account the offsets of all sub-images. Non-clutter objects imaged in the scene may have a large enough spatial extent to cover several pixels in the radar image. These several pixels associated with each non-clutter object are contained in the global set in an unorganized fashion.

Once within the global set of coordinates, the non-clutter pixels are then clustered based on each pixel's proximity to other non-clutter pixels. The global set is processed to yield a set of non-intersecting subsets, where each subset contains only pixels that correspond to a single non-clutter object. The clustering operation utilizes the fact that pixels of the same non-clutter object should be connected to each other by proximity. (Step 60).

Once the non-clutter pixels have been clustered together, each group may be processed further to determine what kind of object was captured in the image. A shape or image recognition process may be applied to the resulting clusters of non-clutter pixels. The shape recognition process can compare the cluster of sub-images to known shapes of seaborne objects such as ships, ice bergs, whales, etc. Once a match or a close enough match is made between the clustered sub-images and one of the known shapes, a match may be considered to be made and that a known object has been found in the input SAR image. If a match for a ship or ships has been found, an alert can be sounded and a sub-image of the area around the detected ship or ships can be created from the input image. This created sub-image can then be sent to another facility for either further analysis or for alert purposes. In addition to the dimension and shape of the objects, more advanced radar systems, such as multi-aperture SARs, may be used to estimate the velocity/speed of the objects detected.

It should be noted that the above method can be implemented for use on-board a satellite. Instead of downloading SAR images containing extensive amount of data by way of a downlink from the satellite to an Earth station, the satellite can perform the automated analysis and ship detection process on the SAR image. Detected ships and objects can then directly be reported to the users and, if necessary, small images of those detected ships can be downlinked as well. In addition of avoiding expensive ground station infrastructure, this would greatly reduce the data volume and, in turn, the latency time required to detect and report ships in a specific region of ocean or sea.

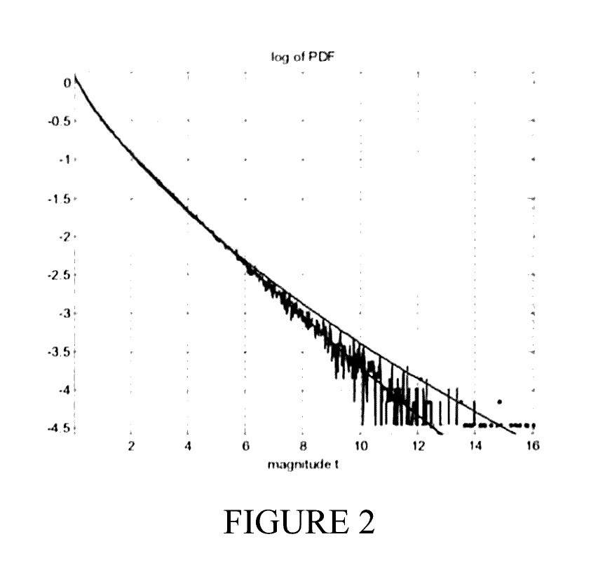

It should also be noted that the novel model for sea clutter, for clarity, models sea clutter as being discrete in nature and not as a continuous texture model. This new model also accounts for the additive thermal noise contribution and can be used to compute the desired texture parameters and detection thresholds. FIG. 2 is a plot of the logarithm of the estimated distribution function of sea clutter overlaid by the optimally fit K-distribution (red) and the new discrete texture model (black) for sea clutter. As can be seen from FIG. 2, the new discrete texture model outperforms the K-distribution model.

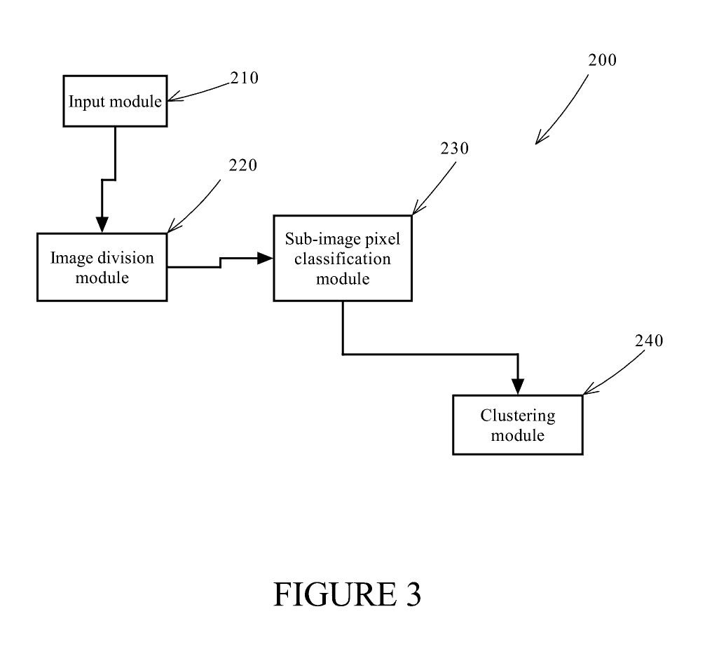

Referring to FIG. 3, a system for use in implementing one aspect of the invention is illustrated. This system 200 uses an input module 210, an image division module 220, a sub-image pixel classification module 230, a clustering module 240, and a shape detection module 250.

The input module 210 receives the input SAR image, either from the SAR itself or from a data file or files. Any preprocessing to prepare the image is performed by the input module 210.

Once the SAR image has been received, the input image is then passed to the image division module 220. The image division module 220 divides the input image into multiple sub-images based on the desired implementation. As noted above, the segmentation may be done by region, content, or sub-image size. Other options are, of course, possible.

The divided sub-images are then passed to the pixel classification module 230. This module checks each sub-image and estimates the clutter model parameters within that sub-image. The parameters are then used to calculate the non-clutter detection threshold for that sub-image, and the threshold is applied to each pixel within that sub-image. If a pixel in that sub-image does not meet or exceed the threshold, then that pixel is classified as being a clutter pixel. If the pixel content meets or exceeds the detection threshold, then that pixel is classified as a non-clutter pixel. This module would implement and apply the novel discrete texture model for sea clutter noted above.

Once the pixels containing non-clutter information for each sub-image have been detected, these pixels are then clustered by the clustering module 240 based on each pixel's proximity to other non-clutter pixels. The clustered pixels may be further processed if necessary. Clustering may involve moving clustered pixels together into a different area in computer memory such that the clustered pixels are stored together and can form a single image.

As noted above, detected ships and objects can be reported and their image can be included in the report.

The system illustrated in FIG. 3 may be implemented as being on-board a satellite carrying a synthetic aperture radar to provide processing capabilities once the SAR images have been produced. Alternatively, the system may be implemented on a ground station so that SAR images, whether received from a satellite based SAR or an airborne SAR, can be processed to detect seaborne objects.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”, “MATLAB”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for processing a radar image to detect at least one object in said image, the method comprising:
a) receiving said radar image;
b) dividing said image into multiple sub-images;
c) processing each sub-image by:
i) estimating parameters from said sub-image for use in calculating a texture random variable;
ii) calculating a detection threshold for said sub-image based on said parameters estimated in step i);
iii) for each pixel in said sub-image, determining if said pixel contains clutter or non-clutter content based on said detection threshold;
iv) for each pixel in said sub-image, classifying said pixel as containing clutter or non-clutter content based on a determination in step iii);
v) saving coordinates of each pixel containing non-clutter content into a global set of non-clutter pixels;
d) repeating step c) until all sub-images have been processed;
e) processing said global set of non-clutter pixels to result in subsets of pixels containing non-clutter content, each subset containing pixels having non-clutter content from a specific object, pixels in each subset being within a predetermined proximity to one another;
wherein said radar image is an image of a section of sea; and
wherein said radar image is produced by a synthetic aperture radar.

2. A method according to claim 1 wherein said method is executed by a system on-board a satellite.

3. A method according to claim 2 wherein said satellite contains said synthetic aperture radar.

4. A method according to claim 1 wherein said texture random variable is a discrete random variable with a probability density function of:
$${f}_{\sum } ( σ ) = {\sum }_{i = 1}^{I} {c}_{i} δ ( σ - {a}_{i} ) {\sum }_{i = 1}^{I} {c}_{i} = 1$$
wherein
aᵢ defines a set of values that said texture random variable can assume;
cᵢ defines a probability of said texture random variable being selected randomly; and
I is a finite number which defines a number of values in said set of values.

5. A method according to claim 1 wherein said subsets of pixels are processed further to determine if non-clutter content indicates a presence of a seaborne vessel.

6. A method according to claim 5 wherein a presence of a seaborne vessel in said subsets of pixels generates a report of said presence.

7. A method according to claim 5 wherein a presence of an object other than a seaborne vessel in said subsets of pixels generates a report of said presence.

8. A method according to claim 1 wherein said detection threshold is calculated using:
$${P}_{fa} ( η , Θ ) = 1 - {F}_{T} ( η , Θ ) = {\sum }_{i = 1}^{I} {c}_{i} \frac{Γ ( n , \frac{ηη}{{ρ}_{c} {a}_{i}^{2} + {ρ}_{n}} )}{Γ ( n )}$$
where
P_{fa} is a pre-determined false alarm rate;
Γ(•) represents a gamma function;
Γ(•, •) represents an incomplete gamma function;
n denotes a number of independent samples averaged;
Θ denotes a vector containing all unknown parameters;
σ_{c}² denotes a clutter noise power level; and
σₙ² denotes a thermal noise power level.

9. A system for processing radar images, the system comprising:
an input module for receiving a radar image;
an image divider module for dividing said radar image into sub-images;
a non-clutter detection module for processing sub-images derived from said input radar image, said detection module determining if pixels in a sub-image contains clutter or non-clutter information;
a clustering module for determining a location of pixels containing non-clutter information in said sub-images and for creating subsets of pixels containing non-clutter information, pixels in a subset being within a predetermined distance from other pixels in said subset;
wherein
said non-clutter detection module processes each of said sub-images by calculating a detection threshold based on parameters from said sub-image and comparing information from each pixel in said sub-image with said detection threshold.

10. A system according to claim 9 wherein said parameters are for calculating a texture random variable.

11. A system according to claim 10 wherein said texture random variable is a discrete random variable with a probability density function of:
$${f}_{\sum } ( σ ) = {\sum }_{i = 1}^{I} {c}_{i} δ ( σ - {a}_{i} ) {\sum }_{i = 1}^{I} {c}_{i} = 1$$
wherein
aᵢ defines a set of values that said texture random variable can assume;
cᵢ defines a probability of said texture random variable being selected randomly; and
I is a finite number which defines a number of values in said set of values.

12. A system according to claim 9 wherein said radar image is produced by a synthetic aperture radar.

13. A system according to claim 9 wherein said radar image is an image of a section of open water.

14. A system according to claim 9 wherein said system is onboard a satellite.

15. A system according to claim 14 wherein said system is on-board a satellite containing said synthetic aperture radar.

16. A system according to claim 9 wherein said detection threshold is calculated using:
$${P}_{fa} ( η , Θ ) = 1 - {F}_{T} ( η , Θ ) = {\sum }_{i = 1}^{I} {c}_{i} \frac{Γ ( n , \frac{ηη}{{ρ}_{c} {a}_{i}^{2} + {ρ}_{n}} )}{Γ ( n )}$$
where
P_{fa} is a pre-determined false alarm rate,
Γ(•) represents a gamma function;
Γ(•, •) represents an incomplete gamma function;
n denotes a number of independent samples averaged;
Θ denotes a vector containing all unknown parameters;
σ_{c}² denotes a clutter noise power level; and
σₙ² denotes a thermal noise power level.

17. Non-transitory computer readable media having encoded thereon computer readable and computer executable instructions which, when executed, implements a method for processing a radar image to detect at least one object in said image, the method comprising:
a) receiving said radar image;
b) dividing said image into multiple sub-images;
c) processing each sub-image by:
i) estimating parameters from said sub-image for use in calculating a texture random variable;
ii) calculating a detection threshold for said sub-image based on said parameters estimated in step i)
iii) for each pixel in said sub-image, determining if said pixel contains clutter or non-clutter content based on said detection threshold;
iv) for each pixel in said sub-image, classifying said pixel as containing clutter or non-clutter content based on a determination in step iii)
v) saving coordinates of each pixel containing non-clutter content into a global set of non-clutter pixels;
d) repeating step c) until all sub-images have been processed;
e) processing said global set of non-clutter pixels to result in subsets of pixels containing non-clutter content, each subset containing pixels having non-clutter content from a specific object, pixels in each subset being within a predetermined proximity to one another;
wherein said radar image is an image of a section of sea; and
wherein said radar image is produced by a synthetic aperture radar.

18. Non-transitory computer readable media according to claim 16 wherein said texture random variable is a discrete random variable with a probability density function of:
$${f}_{\sum } ( σ ) = {\sum }_{i = 1}^{I} {c}_{i} δ ( σ - {a}_{i} ) {\sum }_{i = 1}^{I} {c}_{i} = 1$$
wherein
aᵢ defines a set of values that said texture random variable can assume;
cᵢ defines a probability of said texture random variable being selected randomly; and
I is a finite number which defines a number of values in said set of values.
